(19) United States
(12) Patent Application Publication
(10) Pub. No.: US 2022/0380618 A1
(43) Pub. Date: Dec. 1, 2022

(54) ERASABLE INK SET, ERASABLE INK PRINTING APPARATUS, INK SET CONTAINER, PRINTING METHOD, AND RECORDING MEDIUM

(71) Applicant: BROTHER KOGYO KABUSHIKI KAISHA, Nagoya (JP)

(72) Inventors: MITSUNORI MAEDA, Nagoya (JP); YUKA TSUZAKA, Nagoya (JP)

(73) Assignee: BROTHER KOGYO KABUSHIKI KAISHA, Nagoya (JP)

(21) Appl. No.: 17/826,371

(22) Filed: May 27, 2022

(30) Foreign Application Priority Data
May 31, 2021 (JP) 2021-091386

(51) Int. Cl. C09D 11/54; C09D 11/037; C09D 11/102; B41M 7/00

(52) U.S. Cl. CPC C09D 11/54; C09D 11/037; C09D 11/102; B41M 7/0009

(57) ABSTRACT

An erasable ink set includes: an erasable ink; and an erasing time adjuster which is stored separately from the erasable ink and is capable of adjusting an erasing time of the erasable ink. The erasable ink includes a color developing agent including a pH indicator, water, and at least one selected from the group consisting of a first water-soluble organic solvent and a first surfactant. The erasing time adjuster includes water and at least one selected from the group consisting of a second water-soluble organic solvent and a second surfactant.

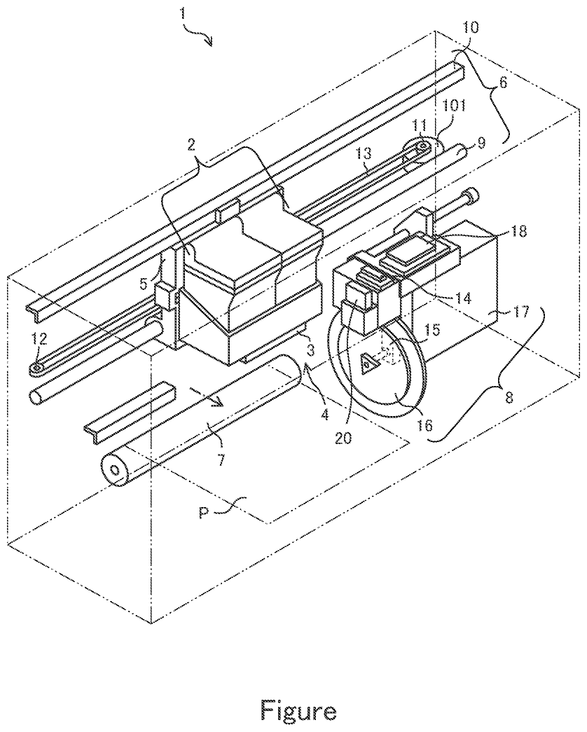

### CROSS-REFERENCE TO RELATED APPLICATION

This application claims priority from Japanese Patent Application No. 2021-091386 filed on May 31, 2021. The entire disclosure of the Japanese Patent Application is incorporated herein by reference.

### BACKGROUND

### Technical Field

The present disclosure relates to an erasable ink set, an erasable ink printing apparatus, an ink set container, a printing method, and a recording medium.

### RELATED ART

Erasable inks may include a pH indicator which develops color in an alkaline state, for example, with phenolphthalein or the like, and erases color in a neutral state.

### SUMMARY

An aspect of the present disclosure is an erasable ink set which includes: an erasable ink; and an erasing time adjuster which is stored separately from the erasable ink and is capable of adjusting an erasing time of the erasable ink. The erasable ink includes a color developing agent, water, and at least one selected from the group consisting of a first water-soluble organic solvent and a first surfactant, the color developing agent includes a pH indicator, and the erasing time adjuster includes water and at least one selected from the group consisting of a second water-soluble organic solvent and a second surfactant. Here, the first water-soluble organic solvent and the second water-soluble organic solvent may be the same or different from each other. The first surfactant and the second surfactant may be the same or different from each other.

Another aspect of the present disclosure is an erasable ink printing apparatus including: the above-described erasable ink set; a first flow path to which the erasable ink is supplied in operation; a first application unit communicating with the first flow path and configured to apply the erasable ink to a recording medium; a second flow path to which the erasing time adjuster is supplied in operation; and a second application unit communicating with the second flow path and configured to apply the erasing time adjuster to the recording medium.

A further aspect of the present disclosure is an ink set storage container including the above-described erasable ink set.

A further aspect of the present disclosure is a printing method including applying the above-described erasable ink set to a recording medium such that the erasable ink and the erasing time adjuster are separately applied to the recording medium.

A further aspect of the present disclosure is a recording medium including: a substrate; and the above-described erasable ink set, printed on the substrate, wherein the erasable ink and the erasing time adjuster is separately applied.

The foregoing paragraphs have been provided by way of general introduction and are not intended to limit the scope of the following claims. The described embodiments, together with further advantages, will be best understood by reference to the following detailed description taken in conjunction with the accompanying drawing.

### BRIEF DESCRIPTION OF THE DRAWINGS

The FIGURE is a schematic perspective view showing a configuration of an exemplary ink jet recording apparatus.

### DETAILED DESCRIPTION OF EMBODIMENTS

Embodiments of the present disclosure will now be described more fully hereinafter with reference to the accompanying drawing, in which some, but not all of the embodiments of the disclosure are shown.

As used herein, the words “a” and “an” and the like carry the meaning of “one or more.”. When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

<Erasable Ink Set>

The erasable ink set (hereinafter, also referred to as an “ink set”) will be described. The ink set of an embodiment of the present disclosure includes: an erasable ink; and an erasing time adjuster which is stored separately from the erasable ink and is capable of adjusting an erasing time of the erasable ink. The erasable ink includes a color developing agent including a pH indicator, water, and at least one selected from the group consisting of a first water-soluble organic solvent and a first surfactant. The erasing time adjuster includes water and at least one selected from the group consisting of a second water-soluble organic solvent and a second surfactant.

(Erasable Ink)

As described above, the erasable ink includes, a color developing agent, water, and at least one of selected from the group consisting of a first water-soluble organic solvent and a first surfactant, and the color developing agent includes a pH indicator.

The pH indicator is, for example, a reagent which discolors by a change in hydrogen ion concentration (change in pH) in a solution, a reagent which develops color in an alkaline state (for example, pH 9.8 to 13.4), a reagent which softens in shade of color as pH is shifted to a neutral side, and/or a reagent which erases (fades) color when pH is in a neutral state (for example, pH 8.5 or less). A specific example of the pH indicator is at least one selected from the group consisting of phenolphthalein, thymolphthalein, and o-cresolphthalein. A single pH indicator may be used alone or two or more pH adjusters may be used in combination. In the erasable ink, the amount of the pH indicator is not particularly limited, and may be in the range of, for example, from 0.1 wt % to 3.0 wt %, preferably, from 0.1 wt % to 2.0 wt %, more preferably from 0.2 wt % to 1.0 wt %.

The solubility parameter (SP) value of the first water-soluble organic solvent is not particularly limited, and may be, for example, 12 or less or 12 or more. The first water-soluble organic solvent may include one or more humectants for preventing the ink from drying at a nozzle tip of an ink-jet head and one or more penetrants for adjusting a drying speed on a recording medium. Namely, the first water-soluble organic solvent can work as a humectant or a penetrant. The first water-soluble organic solvent may have a SP value of 12 or less, preferably, 11 or less. Specific examples of the first water-soluble organic solvent include isopropanol (SP value: 11.5), n-butanol (SP value: 11.3), polyethylene glycol (SP value: 12.0) with a molecular weight of 200, tripropylene glycol (SP value: 11.5), 1,2-hexanediol (SP value: 11.8), propylene glycol monomethyl ether (SP value: 10.2), triethylene glycol-n-butyl ether (SP value: 9.8), tripropylene glycol-n-butyl ether (SP value: 9.2), 2-pyrrolidone (SP value: 11.4), and triethylene glycol monobutyl ether (also referred to as butoxyglycol, butyltriglycol, or BTG, SP value: 10.3). A single first water-soluble organic solvent may be used alone or two or more first water-soluble organic solvents may be used in combination.

In the present disclosure, the SP value is, for example, a value determined using the following equation according to the Fedors method, and the unit of the SP value is (cal/cm³)^{1/2}.

SP value=(ΣΔei/ΣΔvi)^{1/2}
Δei: evaporation energy of atoms and atomic groups (cal/mol)
Δvi: molar volume (cm³/mol)

The first surfactant may have a SP value of 12 or less, preferably 11 or less. As the first surfactant, for example, a commercially available product may be used. As a specific example of the first surfactant, acetylene glycol-based surfactants such as “SURFYNOL® 440” (SP value: 10) produced by Air Products and Chemicals, Inc., “OLFINE® E1010” (SP value: 10.14) produced by Nissin Chemical Industry Co., Ltd., and the like may be used. A single first surfactant may be used alone or two or more first surfactants may be used in combination.

The amount of the first water-soluble organic solvent and the first surfactant based on the total amount of the erasable ink may be, for example, 0.05 wt % to 5.0 wt %, preferably 0.05 wt % to 3.0 wt %, more preferably 0.05 wt % to 2.0 wt %, even more preferably 0.05 wt % to 0.3 wt %. In the erasable ink, the amount of the first water-soluble organic solvent and the first surfactant is, for example, the sum of the amount of the first water-soluble organic solvent and the amount of the first surfactant.

The weight content ratio of the first water-soluble organic solvent and the first surfactant in the erasable ink is, for example, equal to or less than the weight content ratio of the second water-soluble organic solvent and the second surfactant in the erasing time adjuster, as described below. In this disclosure, a “weight content ratio of A in B” means an amount of A (in terms of wt %) in B.

The erasable ink may include one or more humectants. The humectant is not particularly limited, and examples thereof include lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols such as diacetone alcohol; ethers such as tetrahydrofuran and dioxane; polyethers such as polyalkylene glycols; polyhydric alcohols such as alkylene glycol, glycerin, trimethylolpropane, and trimethylolethane; 2-pyrrolidone; N-methyl-2-pyrrolidone; and 1,3-dimethyl-2-imidazolidinone. Examples of the polyalkylene glycol include polyethylene glycol and polypropylene glycol. Examples of the alkylene glycol include ethylene glycol, propylene glycol, butylene glycol, diethylene glycol, triethylene glycol, dipropylene glycol, tripropylene glycol, thiodiglycol, and hexylene glycol. A single humectant may be used alone or two or more humectants may be used in combination.

The amount of the humectant relative to the total amount of the erasable ink may be in the range, for example, from 0 wt % to 99.6 wt %, preferably 0 wt % to 80 wt %, more preferably 0 wt % to 50 wt %, even more preferably 0 wt % to 15 wt %. When a humectant is also the first water-soluble organic solvent, an amount of the humectant is included in the amount of the first water-soluble organic solvent, when the amount of the first water-soluble organic is calculated.

The erasable ink may include one or more penetrants. The penetrant may be, for example, glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. A single penetrant may be used alone or two or more penetrants may be used in combination.

The amount of the penetrant relative to the total amount of the water-based ink for ink jet recording may be in the range of, for example, from 0 wt % to 99.6 wt %, preferably from 0 wt % to 80 wt %, more preferably from 0 wt % to 50 wt %, even more preferably from 0 wt % to 15 wt %. When a penetrant is also the first water-soluble organic solvent, an amount of the penetrant is included in the amount of the first water-soluble organic solvent, when the amount of the first water-soluble organic is calculated.

The erasable ink may include, for example, one or more pH adjusters. Examples of the pH adjuster include an alkali metal hydroxide, an alkali metal carbonate, a hydroxide of a Group II to Group XII element, a carbonate of a Group II to Group XII element, and an amine. Specific examples of the pH adjuster include sodium hydrogen carbonate, potassium carbonate, calcium carbonate, sodium hydroxide, sodium carbonate, triethanolamine, N-butyldiethanolamine, sodium citrate (disodium citrate, trisodium citrate), sodium hydrogen carbonate, potassium phosphate (potassium dihydrogen phosphate, dipotassium hydrogen phosphate, tripotassium phosphate), trisodium phosphate, sodium hydrogen phosphate (disodium hydrogen phosphate, sodium dihydrogen phosphate), and sodium dihydrogen pyrophosphate. Among these, sodium hydrogen carbonate, potassium carbonate, calcium carbonate, sodium hydroxide, sodium carbonate, triethanolamine, and N-butyldiethanolamine are preferred. A single pH adjuster may be used alone or two or more pH adjusters may be used in combination. In the erasable ink, the amount of the pH adjuster may be, for example, an amount in which the pH of the erasable ink is in the range that allows the pH indicator to develop color. The range of pH that allows the pH indicator to develop color is, for example, from pH 9.8 to pH 13.4. The amount of the pH adjuster based on the total amount of the erasable ink is, for example, 5 wt % or less.

The water may be, for example, ion-exchanged water or pure water. The amount (water ratio) of the water relative to the total amount of the erasable ink is appropriately determined according to desired ink characteristics and the like. The water ratio may be, for example, a balance of the other components. The amount of the water is in the range, for example, from 60 w % to 95 wt %, preferably from 65 w % to 85 wt %, more preferably from 70 w % to 85 wt %.

The erasable ink may further include one or more other additives as needed. Examples of other additives include a viscosity modifier, a surface tension modifier, and a mildewproofing agent. Examples of the viscosity modifier include polyvinyl alcohol, cellulose, and a water-soluble resin.

(Erasing Time Adjuster)

In embodiments, the erasing time adjuster includes water and at least one selected from the group consisting of a second water-soluble organic solvent and a second surfactant, as described above.

The SP value of the second water-soluble organic solvent is not particularly limited, and may be, for example, 12 or less or 12 or more. The second water-soluble organic solvent may include one or more humectants for preventing the ink from drying at a nozzle tip of an ink-jet head and one or more penetrants for adjusting a drying speed on a recording medium. Namely, the second water-soluble organic solvent can work as a humectant or a penetrant. The second water-soluble organic solvent may have a SP value of 12, preferably 11 or less. Specific examples of the second water-soluble organic solvent include isopropanol (SP value: 11.5), n-butanol (SP value: 11.3), polyethylene glycol (SP value: 12.0) with a molecular weight of 200, tripropylene glycol (SP value: 11.5), 1,2-hexanediol (SP value: 11.8), propylene glycol monomethyl ether (SP value: 10.2), triethylene glycol-n-butyl ether (SP value: 9.8), tripropylene glycol-n-butyl ether (SP value: 9.2), 2-pyrrolidone (SP value: 11.4), and triethylene glycol monobutyl ether (also referred to as butoxyglycol, butyltriglycol, or BTG, SP value: 10.3). A single second water-soluble organic solvent may be used alone or two or more second water-soluble organic solvent may be used in combination.

The second surfactant may have a SP value of 12 or less, preferably 11 or less. As the second surfactant, for example, a commercially available product may be used. As a specific example of the second surfactant, an acetylene glycol-based surfactant such as “SURFYNOL® 440” (SP value: 10) produced by Air Products and Chemicals, Inc., “OLFINE® E1010” (SP value: 10.14) produced by Nissin Chemical Industry Co., Ltd., and the like may be used. A single second surfactant may be used alone or two or more second surfactants may be used in combination.

The amount of the second water-soluble organic solvent and the second surfactant based on the total amount of the erasing time adjuster may be, for example, 0.5 wt % or more, 2.0 wt % or more, preferably 3.0 wt % or more, more preferably 5.0 wt % or more. The amount of the second water-soluble organic solvent and the second surfactant in the erasing time adjuster is, for example, the sum of the amount of the second water-soluble organic solvent and the amount of the second surfactant.

The weight content ratio of the second water-soluble organic solvent and the second surfactant in the erasing time adjuster is, for example, equal to or more than the weight content ratio of the first water-soluble organic solvent and the first surfactant in the erasable ink.

The erasing time adjuster may include one or more humectants. The humectant is not particularly limited, and examples thereof include lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols such as diacetone alcohol; ethers such as tetrahydrofuran and dioxane; polyethers such as polyalkylene glycols; polyhydric alcohols such as alkylene glycol, glycerin, trimethylolpropane, and trimethylolethane; 2-pyrrolidone; N-methyl-2-pyrrolidone; and 1,3-dimethyl-2-imidazolidinone. Examples of the polyalkylene glycol include polyethylene glycol and polypropylene glycol. Examples of the alkylene glycol include ethylene glycol, propylene glycol, butylene glycol, diethylene glycol, triethylene glycol, dipropylene glycol, tripropylene glycol, thiodiglycol, and hexylene glycol. A single humectant may be used alone or two or more humectants may be used in combination.

The amount of the humectant relative to the total amount of the erasing time adjuster may be in the range of, for example, from 0 wt % to 99.5 wt %, preferably from 0 wt % to 90 wt %, more preferably from 0 wt % to 50 wt %, even more preferably from 0 wt % to 20 wt %. When a humectant is also the second water-soluble organic solvent, an amount of the humectant is included in the amount of the second water-soluble organic solvent, when the amount of the second water-soluble organic is calculated.

The erasing time adjuster may include penetrants. The penetrant may be, for example, glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. A single penetrant may be used alone or two or more penetrants may be used in combination.

The amount of the penetrant relative to the total amount of the erasing time adjuster may be in the range of, for example, from 0 wt % to 99.5 wt %, preferably from 0 wt % to 90 wt %, more preferably from 0 wt % to 50 wt %, even more preferably from 0 wt % to 20 wt %. When a penetrant is also the second water-soluble organic solvent, an amount of the penetrant is included in the amount of the second water-soluble organic solvent, when the amount of the second water-soluble organic is calculated.

The water may be ion-exchanged water or pure water. The amount (water ratio) of the water relative to the total amount of the erasing time adjuster is appropriately determined according to desired characteristics and the like. The water ratio may be, for example, a balance of the other components. The amount of the water is in the range of, for example, from 60 wt % to 90 wt %, from 65 wt % to 85 wt %, or from 70 wt % to 85 wt %.

The erasing time adjuster may further include one or more other additives as needed. Examples of the other additives include a pH adjuster, a viscosity modifier, a surface tension modifier, and a mildewproofing agent. Examples of the viscosity modifier include polyvinyl alcohol, cellulose, and a water-soluble resin.

The erasable ink set including the erasable ink and the erasing time adjuster may be used, for example, but not limited to, for ink-jet recording. The erasable ink set may also be used in applications such as, for example, writing instruments such as pens, markers, and brushes; and coating materials.

<Ink Set Container>

Next, an ink set container which includes an ink set will be described. Examples of the ink set container include an ink cartridge, a tank, and a pouch. As the main body of the ink set container, for example, a conventionally known container may be used.

<Erasable Ink Printing Apparatus>

Next, an erasable ink printing apparatus (hereinafter also referred to as a “printing apparatus”) will be described.

The erasable ink printing apparatus includes: a first flow path; a first application unit; a second flow path; and a second application unit, wherein the first flow path is supplied with the erasable ink of the erasable ink set, the second flow path is supplied with the erasing time adjuster of the erasable ink set, the first application unit communicates with the first flow path, the second application unit communicates with the second flow path, the first application unit applies the erasable ink to a recording medium, and the second application unit applies the erasing time adjuster to the recording medium.

Examples of the recording medium include paper such as recording paper; and fabrics such as knitted fabrics and woven fabrics. The material of the fabric may be, for example, natural fibers or synthetic fibers. Examples of the natural fiber include cotton and silk. Examples of the to synthetic fiber include urethane, acrylic, polyester, and nylon.

The printing apparatus may further include, for example, a control unit that controls an application amount of the erasing time adjuster applied to the recording medium by the second application unit. The control unit controls the second application unit to increase the application amount of the erasing time adjuster to be more than a predetermined amount when shortening an erasing time of the erasable ink to be shorter than a predetermined time and to reduce the application amount of the erasing time adjuster to be less than a predetermined amount when extending the erasing time of the erasable ink to be longer than the predetermined time, thereby controlling the application amount of the erasing time adjuster.

The control unit may, for example, control the order of the application of the erasable ink to the recording medium by the first application unit and the application of the erasing time adjuster to the recording medium by the second application unit, and may apply the erasable ink after the application of the erasing time adjuster.

The FIGURE shows a configuration of an example of the printing apparatus. As shown in the FIGURE, the printing apparatus 1 includes an ink cartridge 2 including a first ink cartridge and a second ink cartridge, an ink ejection unit (ink jet head) 3 including a first application unit and a second application unit, a head unit 4, a carriage 5, a drive unit 6, a platen roller 7, and a purge device 8 as main components. Although it is not shown in the FIGURE, the first ink cartridge of the ink cartridge 2 and the first application unit of the ink ejection unit 3 are connected by a first flow path, the erasable ink is supplied from the first ink cartridge containing the erasable ink to the first flow path, and the first application unit ejects the erasable ink on a recording medium. Further, the second ink cartridge of the ink cartridge 2 and the second application unit of the ink ejection unit 3 are connected by a second flow path, the erasing time adjuster is supplied from the second ink cartridge containing the erasing time adjuster to the second flow path, and the second application unit ejects the erasing time adjuster on the recording medium.

As described above, the ink cartridge 2 includes the first ink cartridge containing the erasable ink and the second ink cartridge containing the erasing time adjuster, for example. As the main body of the ink cartridge, for example, a conventionally known body may be used.

Also, although it is not shown in the FIGURE, the printing apparatus 1 may include, in addition to the ink cartridge 2, a set of four ink cartridges each containing each of four water-based color inks, yellow, magenta, cyan, and black. In addition, in place of the set of four ink cartridges, an integrated ink cartridge in which the inside thereof is partitioned so as to form a water-based yellow ink storage portion, a water-based magenta ink storage portion, a water-based cyan ink storage portion, and a water-based black ink storage portion may be used.

The inkjet head 3 installed in the head unit 4 performs recording on a recording medium (for example, recording paper) P. The ink cartridge 2 and the head unit 4 are mounted on the carriage 5. The drive unit 6 reciprocates the carriage 5 in the linear direction. As the drive unit 6, for example, a conventionally known drive unit may be used (see, for example, US2008/241398, the contents of which are hereby incorporated into the present specification). The platen roller 7 extends in the reciprocating direction of the carriage 5 and is disposed to face the ink jet head 3.

The purge device 8 sucks defective ink containing bubbles and the like pooled inside the inkjet head 3. As the purge device 8, for example, a conventionally known purge device may be used (see, for example, US2008/241398).

On the platen roller 7 side of the purge device 8, a wiper member 20 is disposed adjacent to the purge device 8. The wiper member 20 is formed in a spatula shape and is configured to wipe the nozzle forming surface of the ink jet head 3 in accordance with the movement of the carriage 5. In the FIGURE, the cap 18 is configured to cover a plurality of nozzles of the inkjet head 3 which are configured to return to the reset position when the recording is completed, in order to prevent the ink from drying.

In the printing apparatus 1 of the present embodiment, the ink cartridge 2 is mounted on one carriage 5 together with the head unit 4. However, the printing apparatus 1 is not limited thereto. In the printing apparatus 1, the ink cartridge 2 may be mounted on a carriage which is different from the one on which the head unit 4 is mounted. The ink cartridge 2 may be disposed and fixed in the printing apparatus 1 without being mounted on the carriage 5. In these embodiments, for example, the ink cartridge 2 and the head unit 4 mounted on the carriage 5 are connected by the flow path such as a tube, and the erasable ink and the erasing time adjuster are supplied from the ink cartridge 2 to the head unit 4. In these embodiments, a bottle-shaped ink bottle may be used instead of the ink cartridge 2. In this case, an inlet through which an ink is injected from the outside into the inside may be provided in the ink bottle, for example.

Ink jet recording using the printing apparatus 1 is performed, for example, as follows. First, the recording paper P is fed from a paper feed cassette (not shown) provided on the side or below the printing apparatus 1. The recording paper P is introduced between the inkjet head 3 and the platen roller 7. On the introduced recording paper P, a predetermined recording is performed by the erasing time adjuster ejected from the second application unit of the ink jet head 3 and the erasable ink ejected from the first application unit of the ink jet head 3. The recording sheet P after recording is ejected from the printing apparatus 1. In the FIGURE, a sheet feeding mechanism and a sheet ejecting mechanism of the recording sheet P are not shown.

Although the apparatus shown in the FIGURE employs a serial ink jet head, the apparatus is not limited thereto. The printing apparatus may be an apparatus that employs a line ink jet head or the printing apparatus may be a roll-to-roll printing apparatus.

In the apparatus shown in the FIGURE, the ink-jet head 3 that ejects the erasable ink and the erasing time adjuster by an ink-jet method is employed as the first application unit and the second application. It is to be noted, however, that the apparatus is not limited to this illustrative example. The first application unit and the second application unit may perform application of the erasable ink and the erasing time adjuster by a conventionally known application method such as spraying, stamping, brushing, roller coating, dipping, or the like, for example.

<Printing Method>

A printing method is a printing method using the erasable ink set described above. The erasable ink and the erasing time adjuster are applied to a recording medium. The printing method may be carried out, for example, using the erasable ink printing apparatus. The application includes character-printing, image-printing, printing, and the like.

In the printing method, for example, the application amount of the erasing time adjuster is increased to be more than a predetermined amount when shortening the erasing time of the erasable ink applied to the recording medium to be shorter than a predetermined time. In addition, the application amount of the erasing time adjuster is reduced to be less than a predetermined amount when extending the erasing time of the erasable ink applied to the recording medium to be longer than the predetermined time.

In the printing method, the order of the application of the erasable ink and the erasing time adjuster is not particularly limited, and for example, they may be applied in any order, and the erasable ink and the erasing time adjuster may be applied simultaneously or the erasable ink may be applied after the application of the erasing time adjuster.

<Printed Matter Production Method>

The method for producing a printed matter is characterized in that it includes printing, wherein the printing is performed by the above-described printing method, and other steps and conditions are not particularly limited. According to the method for producing a printed matter, for example, the erasing time of the erasable ink in a printed matter may be controlled.

### EXAMPLES

Examples are described below. The present invention, however, is not limited by the following examples.

(Preparation of Erasable Ink)

Components of the erasable ink composition summarized in Table 1 were uniformly mixed to obtain erasable inks 1 to 6 (inks 1 to 6) of Examples 1 to 6.

TABLE 1

| | | | Ex. 1 | Ex. 2 | Ex. 3 | Ex. 4 | Ex. 5 | Ex. 6 |
|---|---|---|---|---|---|---|---|---|
| | | | Ink 1 | Ink 2 | Ink 3 | Ink 4 | Ink 5 | Ink 6 |
| Ink composition | pH indicator | Thymolphthalein | 1 | 1 | 1 | | | 1 |
| | | Phenolphthalein | | | | 1 | | |
| | | ο-cresolphthalein | | | | | 1 | |
| | Humectant | Triethylene glycol (SP value: 13.6) | 15.0 | 15.0 | 15.0 | 15.0 | 15.0 | 15.0 |
| | First water-soluble | Triethylene glycol monobutyl ether | | 1.5 | 2.5 | | | 4.5 |
| | organic solvent | (SP value: 10.3) | | | | | | |
| | First surfactant | SURFYNOL ® 440 | 0.3 | 0.3 | 0.3 | 0.3 | 0.3 | 0.3 |
| | | (SP value: 10) | | | | | | |
| | pH adjuster | Sodium hydroxide | 4.8 | 4.8 | 4.8 | 4.8 | 4.8 | 4.8 |
| | Solvent | Water | Balance | Balance | Balance | Balance | Balance | Balance |

(Preparation of Erasing Time Adjuster)

Components of the erasing time adjuster composition summarized in Table 2 were uniformly mixed to obtain the erasing time adjuster of Example.

TABLE 2

| | | | |
|---|---|---|---|
| Erasing time adjuster | Humectant | Glycerin (SP value: 20) | 10.0 |
| composition | | Triethylene glycol (SP value: | 10.0 |
| | | 13.6) | |
| | Second water-soluble organic | Triethylene glycol monobutyl | 5.0 |
| | solvent | ether | |
| | | (SP value: 10.3) | |
| | Second surfactant | SURFYNOL ® 440 (SP value: 10) | 0.5 |
| | Solvent | Water | Balance |

The erasable inks 1 to 6 were applied to recording paper (trade name: ASKUL Super White+, ASKUL Corporation) so as to achieve an application amount per unit area of 0.9 mg/cm² (without the erasing time adjuster). The erasing time adjuster was applied to recording paper (trade name: ASKUL Super White+, ASKUL Corporation) so as to achieve the application amount per unit area of 0.9 mg/cm², and then the erasable inks 1 to 6 were applied to the recording paper (trade name: ASKUL Super White+, ASKUL Corporation) to which the erasing time adjuster has been applied, so as to achieve the application amount per unit area of 0.6 mg/cm² (with the erasing time adjuster). Then, the erasing time of the erasable inks 1 to 6 in each of the case where the erasing time adjuster was not applied and the case where the erasing time adjuster was applied was measured.

The erasing time was measured after the application of the erasable ink until the OD value (optical density) became 0. The OD value (optical density) was measured by a spectrocolorimeter SpectroEye® (light source: D50, viewing angle: 2°, ANSI-T) produced by X-Rite.

The results are summarized in Table 3 below. As summarized in Table 3, the erasing time of all of the erasable inks 1 to 6 could be controlled by applying the erasing time adjuster. In particular, the erasing time of the erasable inks 1, 4, and 5 could be adjusted greatly from those with a maximum erasing time longer than 7 d (<7 d) to those with a minimum erasing time less than 3 h (3 h<) by applying or not applying the erasing time adjuster. Thus, the examples showed that the erasing time of the erasing ink can be controlled.

TABLE 3

| | Erasing time | |
|---|---|---|
| | Without erasing | With erasing |
| | time adjuster | time adjuster |
| Erasable ink 1 | <7 d | 3 h< |
| Erasable ink 2 | 5 d | 3 h< |
| Erasable ink 3 | 2 d | 3 h< |
| Erasable ink 4 | <7 d | 3 h< |
| Erasable ink 5 | <7 d | 3 h< |
| Erasable ink 6 | 6 h | 3 h< |

It will be obvious to those having skill in the art that many changes may be made in the above-described details of the particular aspects described herein without departing from the spirit or scope of the invention as defined in the appended claims.

What is claimed is:

1. An erasable ink set comprising:
an erasable ink; and
an erasing time adjuster which is stored separately from the erasable ink and is capable of adjusting an erasing time of the erasable ink, wherein
the erasable ink comprises:
a color developing agent comprising a pH indicator;
water; and
at least one selected from the group consisting of a first water-soluble organic solvent and a first surfactant, and
the erasing time adjuster comprises:
water; and
at least one selected from the group consisting of a second water-soluble organic solvent and a second surfactant.

2. The erasable ink set according to claim 1, wherein
a SP value of each of the first water-soluble organic solvent and the first surfactant is 12 or less,
a SP value of each of the second water-soluble organic solvent and the second surfactant is 12 or less, and
an amount of the first water-soluble organic solvent and the first surfactant by wt % in the erasable ink is equal to or less than an amount of the second water-soluble organic solvent and the second surfactant by wt % in the erasing time adjuster.

3. The erasable ink set according to claim 1, wherein
the amount of the first water-soluble organic solvent and the first surfactant in the erasable ink is 5.0 wt % or less,
the amount of the second water-soluble organic solvent and the second surfactant in the erasing time adjuster is 0.5 wt % or more.

4. The erasable ink set according to claim 3, wherein
the amount of the first water-soluble organic solvent and the first surfactant in the erasable ink is 3.0 wt % or less.

5. The erasable ink set according to claim 3, wherein
the amount of the first water-soluble organic solvent and the first surfactant in the erasable ink is 2.0 wt % or less.

6. The erasable ink set according to claim 3, wherein
the amount of the first water-soluble organic solvent and the first surfactant in the erasable ink is 0.3 wt % or less.

7. The erasable ink set according to claim 1, wherein
a SP value of each of the first water-soluble organic solvent and the first surfactant is 11 or less, and
a SP value of each of the second water-soluble organic solvent and the second surfactant is 11 or less.

8. The erasable ink set according to claim 1, wherein
the pH indicator comprises at least one selected from the group consisting of phenolphthalein, thymolphthalein, and o-cresolphthalein.

9. An erasable ink printing apparatus, comprising:
the erasable ink set according to claim 1;
a first flow path to which the erasable ink is supplied in operation;
a first application unit communicating with the first flow path and configured to apply the erasable ink to a recording medium;
a second flow path to which the erasing time adjuster is supplied in operation; and
a second application unit communicating with the second flow path and configured to apply the erasing time adjuster to the recording medium.

10. The erasable ink printing apparatus according to claim 9, further comprising
a control unit that controls an application amount of the erasing time adjuster applied to the recording medium by the second application unit during operation, wherein the application amount is controlled such that the application amount is increased to shorten an erasing time of the erasable ink applied to the recording medium and the application amount is reduced to extend the erasing time of the erasable ink applied to the recording medium.

11. The erasable ink printing apparatus according to claim 9, further comprising
a control unit that controls an order of application of the erasable ink to the recording medium by the first application unit and application of the erasing time adjuster to the recording medium by the second application unit during operation, wherein the order of application is controlled such that the erasable ink is applied after application of the erasing time adjuster.

12. An ink set storage container, comprising the erasable ink set according to claim 1.

13. A printing method, comprising
applying the erasable ink set according to claim 1 to a recording medium such that the erasable ink and the erasing time adjuster are separately applied to the recording medium.

14. The printing method according to claim 13,
further comprising controlling an application amount of the erasing time adjuster to be greater than or less than a predetermined application amount.

15. The printing method according to claim 13, wherein
the erasable ink is applied after the application of the erasing time adjuster.

16. A recording medium comprising:
a substrate; and
the erasable ink set according to claim 1, printed on the substrate, wherein the erasable ink and the erasing time adjuster is separately applied.
